(19) United States
(12) Patent Application Publication
(10) Pub. No.: US 2025/0338327 A1
(43) Pub. Date: Oct. 30, 2025

(54) SYSTEMS AND METHODS FOR ENHANCED QUALITY OF SERVICE IN WI-FI NETWORKS THROUGH PRE-PROVISIONED TUNNELS

(71) Applicant: PLUME DESIGN, INC., Palo Alto, CA (US)

(72) Inventors: Miroslav SAMARDZIJA, Mountain View, CA (US); Dariusz KOPKA, Warsaw (PL); Metod MEDJA, Ljubljana (SI); Grigor RISTOV, Ljubljana (SI); Gal TRAPECAR, Ljubljana (SI); Liem Hieu Dinh VO, San Jose, CA (US)

(21) Appl. No.: 18/646,886

(22) Filed: Apr. 26, 2024

(51) Int. Cl. H04W 76/12; H04L 69/16

(52) U.S. Cl. CPC H04W 76/12; H04L 69/16

(57) ABSTRACT

Embodiments of the present disclosure relate to systems and methods for enhancing the quality of service in Wi-Fi networks through the use of pre-provisioned cryptographic tunnels. The disclosed system leverages a cloud controller to dynamically manage the topology of distributed Wi-Fi networks. These networks are configured with a tunneling protocol that allows seamless roaming of client devices between different Wi-Fi networks, minimizing disruptions during transitions. The tunneling protocol is stateless with respect to actual connections and employs cryptographic keys for secure and efficient packet transmission. The system is capable of maintaining ongoing connections by using a single cryptographically correct frame to update network paths. A plurality of access points, managed by the cloud-based server, is configured to anticipate potential connections and assume control of active tunneling sessions, thereby enhancing the user experience during network transitions.

### BACKGROUND

In wireless communications, Wi-Fi networks, which include Wireless Local Area Networks (WLANs) based on IEEE 802.11 standards, have become a cornerstone of modern connectivity. These networks facilitate a wire-free environment, enabling users to access a multitude of services, including video streaming, audio streaming, voice calls, video conferencing, online gaming, and security monitoring, as well as traditional data services such as web browsing and file transfers. Wi-Fi has emerged as the primary means of connecting user devices to the Internet across various settings, from residential to public spaces.

Despite the widespread adoption and convenience of Wi-Fi, users frequently encounter performance issues that degrade their experience. The increasing demand for real-time media applications places significant strain on the throughput, latency, jitter, and overall robustness of Wi-Fi networks. While broadband Internet access is typically reliable and fast up to the consumer's premises, the distribution of this connection within the premises via Wi-Fi often fails to meet expectations, leading to a suboptimal user experience.

Several factors contribute to the underperformance of conventional Wi-Fi systems. Interference from overlapping Wi-Fi networks, congestion from multiple high-bandwidth applications, and inadequate coverage due to signal attenuation through physical barriers are primary concerns. These issues result in reduced throughput, network saturation, and unreliable service in certain areas within the environment, such as rooms with weak Wi-Fi signals.

To address these challenges, two main approaches have been employed. The first involves enhancing the capabilities of single access points to extend coverage and improve signal strength. However, this method is limited by regulatory power constraints and diminishing returns on technological advancements. The second approach utilizes repeaters or mesh networks to distribute the Wi-Fi signal throughout a location. While this method offers improved coverage, it introduces a capacity bottleneck due to the shared frequency channel used for backhaul communication, leading to inefficient airtime usage and increased interference.

Current state-of-the-art systems, including mesh and repeater-based configurations, are hindered by their reliance on localized control and a single frequency channel for backhaul communication. This creates a bottleneck where only one transmission can occur at a time on the channel, significantly reducing network capacity and exacerbating interference and congestion issues. For instance, a three-hop transmission within such a system would require three times the airtime compared to a direct transmission, effectively tripling the interference and reducing the network's capacity by a factor of three.

A significant issue arises when a user roams between different Wi-Fi provider networks or Extended Service Sets (ESS-es). Each time a user's device connects to a new provider network, a different Network Address Translation (NAT) specific to that network is deployed. This NAT translates the device's private IP, unique to that Wi-Fi network, to a global public IP. This assignment of a new public IP every time the device roams can lead to a reduction in the Quality of Service (QoS). For instance, if a user is on a video call and roams from one Wi-Fi network to another, the call data is trafficked over two different public IPs, causing disruptions. This frequent change in public IP addresses opens up a host of problems, leading to a subpar user experience.

### SUMMARY

To overcome these challenges the system includes a novel solution that leverages a cloud controller which is communicatively coupled to one or more distributed Wi-Fi networks. In some embodiments, the cloud controller includes a network interface, one or more computers, one or more processors, and one or more non-transitory computer readable media configured to dynamically manage the topology of a Wi-Fi network. The memory (media) includes instructions that, when executed by one or more processors, enable the system to determine a new topology state from the current state, prompting nodes to change their associated parent nodes based on the new state. In some embodiments, this process continues until the desired topology state is achieved. The system also uses a tunneling protocol to transition between according to some embodiments, thereby enabling seamless roaming across Wi-Fi networks and maintaining a consistent user experience and quality of service.

The cloud controller's memory-stored instructions further configure the one or more computers to signal nodes to transition their connections to the new or an intermediate topology state. Once the new topology state is formed, the system can implement additional changes, such as adjustments to channel frequency and bandwidth. In some embodiments, the system is configured to managing firmware/software updates across the network, determining if the network requires a new firmware/software version, pushing this version to all nodes, receiving acknowledgments from the nodes, and initiating an update sequence where each node updates and reboots upon receipt of a specific message.

In some embodiments, a computer implemented method for updating the topology of a distributed Wi-Fi network includes a cloud-based server configured for determining a new topology state, prompting nodes to change their associated parent nodes based on this new state, updating the configuration of these nodes, and repeating this process until the new topology state is achieved.

In some embodiments, the system further enhances the user experience by configuring Access Points (APs) in proximity to the user to expect potential connections from the user's equipment with a dedicated, per-user, UDP-based tunnel terminated in a cloud endpoint. This protocol requires no acknowledgment, making the process more efficient.

In some embodiments, the system includes a tunneling protocol (e.g., Wireguard (WG)) that includes features such as cryptographic identity, automatic silent keep-alives, endpoint update, and quick connection establishment. In some embodiments, the system includes a VPN that uses the tunneling protocol to establish secure connection. In some embodiments, the VPN and/or tunneling protocol allow for a network to be configured in such a way that many APs have a tunnel pre-provisioned for each client that can possibly connect to it. When the client's device roams, the new AP takes over the active tunneling session, triggering updates to the routes. In some embodiments, the system includes a single cryptographically correct frame coming from a new ESS-es NAT to update paths and keep the connection ongoing. This ensures seamless and efficient transitions between networks, significantly enhancing the overall user experience.

### DESCRIPTIONS OF THE DRAWINGS

The features, functionalities, and advantages of the disclosed Wi-Fi system leveraging tunneling protocols and node grouping will become more apparent from the following detailed description and the accompanying drawings, in which reference characters refer to the same parts throughout the various views. The drawings are not necessarily to scale, with emphasis instead being placed upon illustrating the principles of the disclosed system:

FIG. 1 shows a network diagram portraying a distributed Wi-Fi system with cloud-based control, illustrating the interconnection of multiple access points and client devices as part of the disclosed system according to some embodiments of the present disclosure;

FIG. 2 depicts a network diagram contrasting operational differences in the disclosed distributed Wi-Fi system with conventional Wi-Fi configurations, including single access point, mesh, and repeater systems according to some embodiments of the present disclosure;

FIG. 3 illustrates a flowchart detailing a configuration and optimization process for the distributed Wi-Fi system according to some embodiments of the present disclosure;

FIG. 4 shows a block diagram delineating inputs and outputs to an optimization algorithm within the system according to some embodiments of the present disclosure;

FIG. 5 shows a block diagram of functional components of an access point within the distributed Wi-Fi system according to some embodiments of the present disclosure;

FIG. 6 depicts a block diagram of core components of a server, Wi-Fi client device, or user device which may be used within the disclosed system according to some embodiments of the present disclosure;

FIG. 7 shows a network diagram depicting a three-node Wi-Fi network transitioning between two topology states according to some embodiments of the present disclosure;

FIG. 8 depicts a network diagram illustrating a six-node Wi-Fi network and its transition between first and second topology states according to some embodiments of the present disclosure;

FIG. 9 includes a flowchart outlining a first process for topology change within the Wi-Fi network according to some embodiments of the present disclosure;

FIG. 10 is a flowchart depicting a second process for topology change within the Wi-Fi network, implementing parallel changes for efficient network reconfiguration according to some embodiments of the present disclosure;

FIG. 11 is a network diagram illustrating an exemplary operation of the first process for topology change, demonstrating sequential node transitions to achieve the desired network configuration according to some embodiments of the present disclosure;

FIG. 12 is a network diagram illustrating an exemplary operation of the second process for topology change, highlighting the system's ability to simultaneously reconfigure multiple nodes to expedite topology modification according to some embodiments of the present disclosure; and

FIG. 13 is a flowchart of a tunneling protocol utilized by the system to facilitate seamless roaming between Wi-Fi networks, detailing the steps involved in maintaining connection continuity for client devices according to some embodiments of the present disclosure.

### DETAILED DESCRIPTION

In some embodiments, the present disclosure pertains to systems and methods for that facilitate the enhancement of distributed Wi-Fi networks. The systems and methods encompass a distributed Wi-Fi system comprising numerous self-optimizing access points (nodes) governed by cloud-based control. This self-optimization dynamically adjusts the topology and configuration of the multiple access points based on the operational environment.

The access points communicate with each other through backhaul links and with Wi-Fi client devices via client links. Each backhaul link and each client link may utilize different channels based on the optimization, thereby circumventing the limitations typically encountered in Wi-Fi mesh or repeater systems. In some embodiments, the distributed Wi-Fi system comprises a relatively large number of access points compared to conventional deployments, including Wi-Fi mesh or repeater systems. For instance, a typical residential setting may have 6 to 12 or more access points.

In some embodiments, a method for updating the topology of a distributed Wi-Fi network is proposed. This method, facilitated by the novel cloud-based service, involves determining a new topology state, prompting nodes to change their associated parent nodes based on this new state, updating the configuration of these nodes, and repeating this process until the new topology state is achieved.

The aforementioned features enable the configuration of a network in a manner that anticipates potential connections. To prevent interruptions when transferring between different Wi-Fi networks, in some embodiments, one or more Access Points (APs) are equipped with a pre-provisioned tunneling protocol for each client that could potentially connect to it. The tunneling protocol's stateless nature and reliance on cryptographic keys rather than IP addresses mean that even when the device's network environment changes, the VPN connection can continue without interruption. The new access point simply takes over the active session, and the ‘tunnel’ remains intact.

When a client's device elects to roam, the newly selected AP assumes control of the active session. In some embodiments, assuming control activates updates to the routes. In some embodiments, the cloud-based server is configured to receive a single cryptographically correct frame from the new Extended Service Set's (ESS's) Network Address Translation (NAT). This frame updates the paths and ensures the continuation of the connection.

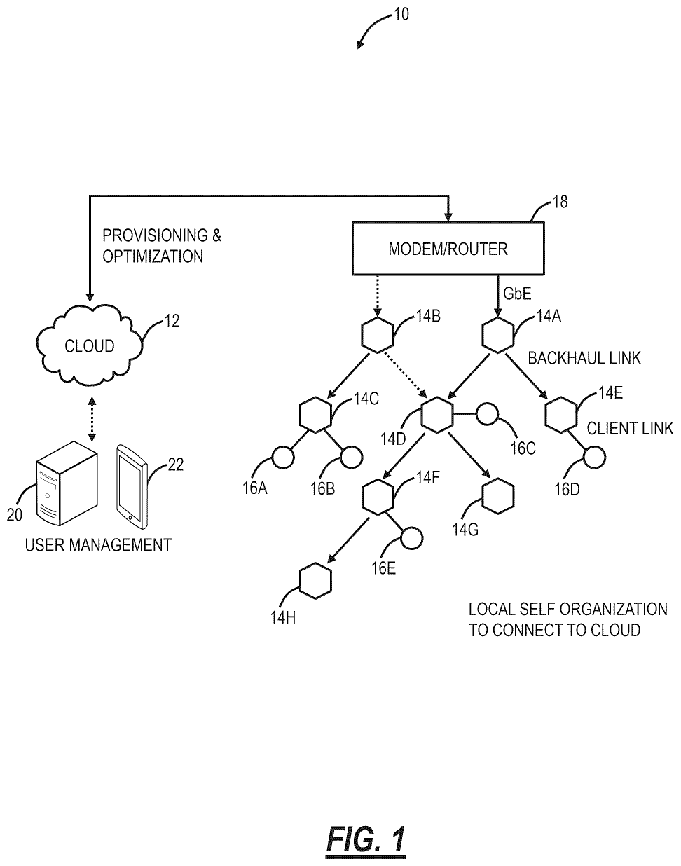

FIG. 1 depicts a distributed Wi-Fi system 10 with cloud-based control 12. In some embodiments, this system adheres to IEEE 802.11 protocols and their variants, comprising multiple access points 14, designated as 14A through 14H, distributed across various locations such as homes or offices. The distributed Wi-Fi system 10 is suitable for environments where single access points, repeaters, or mesh networks are inefficient. The system, which includes a network or a Wi-Fi network, utilizes access points 14, also known as nodes or Wi-Fi nodes, to facilitate network connectivity for Wi-Fi client devices 16, identified as 16A through 16E, and also referred to as client devices or Wi-Fi devices.

In residential settings, for example, the distributed Wi-Fi system 10 may comprise 3 to 12, or more, access points 14, also termed nodes, ensuring minimal distance between each access point 14 and any Wi-Fi client device 16 requiring service. In some embodiments, a system's configuration includes comparable distances between access points 14 and the proximity of Wi-Fi client devices 16 to their nearest access point 14, providing comprehensive Wi-Fi coverage throughout a location (e.g., home). This configuration facilitates short hops within the distributed Wi-Fi system 10, with limited physical obstructions, resulting in strong signal strengths, high data rates, and reliable performance. Wi-Fi client devices 16 encompass a variety of electronics such as mobile devices, tablets, computers, and other network-capable devices. For external network access, select access points 14 connect to a modem/router 18, which may be a cable modem, DSL modem, or similar device, linking the distributed Wi-Fi system 10 to external networks.

Ensuring optimal coverage with numerous access points 14, or nodes, necessitates efficient coordination. Centralized control is used for proper configuration and communication among access points 14, and are managed by cloud-based servers 20 accessible over the Internet in some embodiments. This arrangement allows remote access, for example, through an app on a user device 22, transforming the operation of the distributed Wi-Fi system 10 into a cloud service. Servers 20 process measurement data to analyze and accordingly configure access points 14 via the cloud 12. The servers also determine the connections between Wi-Fi client devices 16 and access points 14.

The distributed Wi-Fi system 10 includes cloud-based control for optimization, configuration (including tunnels), and monitoring, contrasting with traditional local configurations that require direct access point login. Instead, user device 22, or a local Wi-Fi client device 16, communicates with servers 20 through the cloud 12, potentially over a different network, such as LTE or an alternate Wi-Fi network. The access points 14 can include both wireless links and wired links for connectivity. In non-limiting example FIG. 1, the access point 14A has an exemplary gigabit Ethernet (GbE) wired connection to the modem/router 18. Optionally, the access point 14B also has a wired connection to the modem/router 18, such as for redundancy or load balancing.

In some embodiments, the access points 14A, 14B can have a wireless connection to the modem/router 18. In some embodiments, the access points 14 can have wireless links for client connectivity (referred to as a client link) and for backhaul (referred to as a backhaul link). The distributed Wi-Fi system 10 differs from a conventional Wi-Fi mesh network in that the client links and the backhaul links do not necessarily share the same Wi-Fi channel, thereby reducing interference. That is, the access points 14 can support at least two Wi-Fi wireless channels—which can be used flexibly to serve either the client link or the backhaul link and may have at least one wired port for connectivity to the modem/router 18, or for connection to other devices. In the distributed Wi-Fi system 10, only a small subset of the access points 14 require direct connectivity to the modem/router 18 with the non-connected access points 14 communicating with the modem/router 18 through the backhaul links back to the connected access points 14.

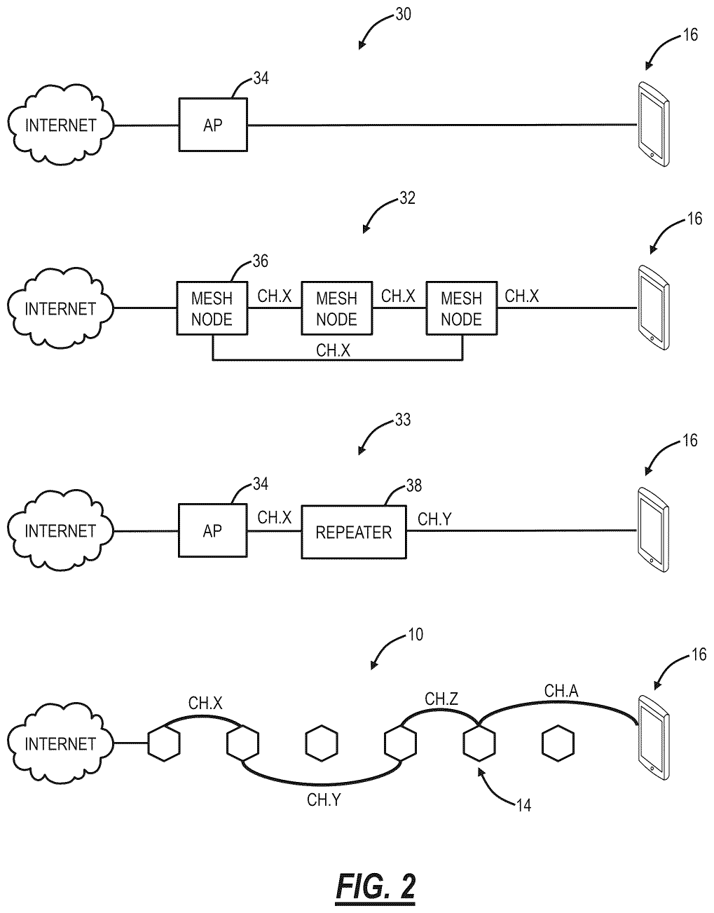

FIG. 2 illustrates a network diagram contrasting the distributed Wi-Fi system 10 with traditional Wi-Fi configurations, including a single access point system 30, a Wi-Fi mesh network 32, and a Wi-Fi repeater network 33. The single access point system 30 utilizes a high-powered central access point 34 to serve all Wi-Fi client devices 16 within a location, such as a home, where physical barriers like walls and floors may impede signal strength. Some single access points operate on a single channel, which may lead to interference from nearby networks. The Wi-Fi mesh network 32 addresses some limitations of the single access point system 30 through multiple interconnected mesh nodes 36, distributing Wi-Fi coverage and sharing a common channel, channel X, among mesh nodes 36 and Wi-Fi client devices 16.

This fully interconnected grid allows for various data paths, but shared backhaul channel use reduces network capacity with each hop. For instance, streaming a video over three hops leaves the Wi-Fi mesh network 32 with a third of the original capacity. The Wi-Fi repeater network 33 features an access point 34 wirelessly connected to a Wi-Fi repeater 38, forming a star topology with a maximum of one repeater 38 between the access point 34 and Wi-Fi client device 16. Communication occurs on two channels, with the access point 34 using channel X to the Wi-Fi repeater 38, and the repeater 38 using a separate channel Y to the Wi-Fi client device 16. The distributed Wi-Fi system 10 solves the problem with the Wi-Fi mesh network 32 of requiring the same channel for all connections by using a different channel or band for the various hops (note, some hops may use the same channel/band, but it is not required), to prevent slowing down the Wi-Fi speed.

For example, the distributed Wi-Fi system 10 can use different channels/bands between access points 14 and between the Wi-Fi client device 16 (e.g., Chs. X, Y, Z, A), and, also, the distributed Wi-Fi system 10 does not necessarily use every access point 14, based on configuration and optimization by the cloud 12. The distributed Wi-Fi system 10 solves the problems of the single access point system 30 by providing multiple access points 14. The distributed Wi-Fi system 10 is not constrained to a star topology as in the Wi-Fi repeater network 33 which at most allows two wireless hops between the Wi-Fi client device 16 and a gateway. Also, the distributed Wi-Fi system 10 forms a tree topology where there is one path between the Wi-Fi client device 16 and the gateway, but which allows for multiple wireless hops unlike the Wi-Fi repeater network 33.

Wi-Fi operates on a simplex protocol, which means that within a network, only one device-to-device communication can take place at any moment. When one device transmits, the others must be in receive mode. In some embodiments, the distributed Wi-Fi system 10, by utilizing different Wi-Fi channels, enables multiple conversations to occur at the same time. This is achieved by assigning distinct channels to different access points 14, thereby reducing interference and network congestion. The server 20, via the cloud 12, automatically sets up the access points 14 with an optimized channel configuration. In some embodiments, the system 10 is configured to adaptively select routes and channels, catering to the dynamic requirements of users and their Wi-Fi client devices 16. In some embodiments, the goal of the distributed Wi-Fi system 10 is to minimize the distance Wi-Fi signals need to travel for both backhaul and client connections, maintaining strong signal quality and minimizing interference, unlike the shared-channel approach of the Wi-Fi mesh network 32 or the use of Wi-Fi repeaters. In some embodiments, the servers 20 in the cloud 12 are configured to fine-tune channel selection to enhance the overall user experience.

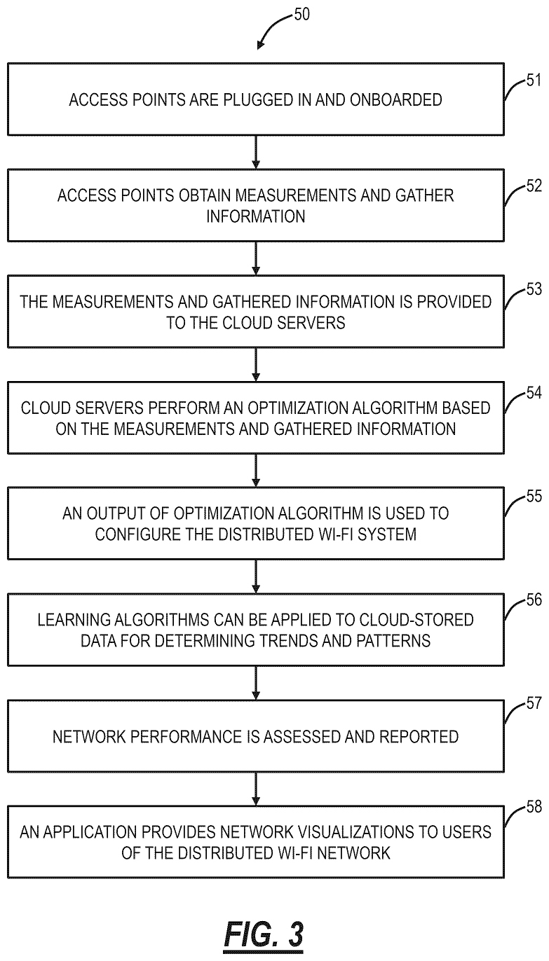

FIG. 3 shows a flowchart illustrating a configuration and optimization process 50 for the distributed Wi-Fi system 10. This process includes one or more of steps 51-58, which can be executed in different sequences and repeated as needed, allowing the system to adapt to changing conditions. Initially, each of the access points 14 is plugged in and onboarded (step 51). In the distributed Wi-Fi system 10, only a subset of access points 14 are wired to the modem/router 18 (or optionally wirelessly connected), and those without wired connectivity must be onboarded to connect to the cloud 12 according to some embodiments. The onboarding step 51 ensures a newly installed access point 14 connects to the system, enabling it to receive commands and send data to the servers 20. In some embodiments, this step may include configuring the access point with the correct Service Set Identifier (SSID) or network ID and associated security keys. In some embodiments, the onboarding step 51 is performed using Bluetooth® or equivalent connectivity between the access point 14 and a user device 22, allowing the user to input the SSID, security keys, etc. Once onboarded, the access point 14 can initiate communication with the servers 20 in the distributed Wi-Fi system 10 for configuration.

The second step includes the access points 14 collecting measurements and information to optimize network settings (step 52). The data collected can include signal strengths and supportable data rates between all nodes, as well as between all nodes and all Wi-Fi client devices 16. In some embodiments, each access point 14 performs this measurement step 52. Additional measurements, such as the amount of interference and the loads or throughputs required by different applications operating over the distributed Wi-Fi system 10, can also be taken. In the third step, the measurements and information collected in step 52 are sent to the servers 20 in the cloud 12 (step 53). In some embodiments, steps 51-53 are carried out on-site at the distributed Wi-Fi system 10.

In some embodiments, nodes perform measurements related to network traffic and connectivity. These measurements may encompass traffic load for each client device, sustainable data rates between nodes and client devices, and packet error rates across links. Additionally, nodes assess interference levels within the network, distinguishing between in-network and out-of-network interferers. In-network interferers, subject to cloud-based control, are considered in network-wide optimization strategies. Conversely, out-of-network interferers, beyond cloud control, necessitate adaptive measures by the system. Out-of-network interferers may include non-cloud controlled Wi-Fi networks and devices operating in Wi-Fi frequencies, such as Bluetooth® devices, baby monitors, and cordless phones, as non-limiting examples.

In some embodiments, nodes may also measure packet delay across the network. Such delays might be determined by timestamping packets upon entry at the gateway and measuring time elapsed upon exit at the terminal node. In some embodiments, this process includes time synchronization among nodes. In some embodiments, delay statistics are measured for each node individually, with average network delay and delay distribution inferred from these individual measurements. Thus, delay thus becomes an optimizable parameter. Additionally, tracking transmission and reception durations at each node, alongside the volume of data transferred, enables the calculation of average data rates sustained by the network links.

In some embodiments, cloud-based servers 20 utilize collected measurements to execute an optimization algorithm for the distributed Wi-Fi system 10, as indicated in step 54. In some embodiments, the algorithm determines optimal network parameters, including channel selection for client and backhaul links, bandwidth allocation per channel, network topology and packet routing, node assignment for client devices, the frequency band for client connections, and tunneling protocols.

In some embodiments, the optimization algorithm incorporates node measurements into an objective function designed for maximization. Link capacity is inferred by analyzing data volume transferred (load) and medium occupancy due to interference. In some embodiments, capacity may be calculated by the ratio of data moved to the proportion of time the transmission queue was active. This capacity reflects the maximum potential throughput under conditions of link saturation and optimal data movement.

In some embodiments, an output of the optimization is used to configure the distributed Wi-Fi system 10 (step 55). In some embodiments, the nodes and client devices are configured from the cloud based on the output of the optimization. In some embodiments, the outputs of the optimization are the operational parameters for the distributed Wi-Fi system 10. In some embodiments, this includes the frequency channels on which each of the nodes is operating, and the bandwidth of the channel to be used. In some embodiments, the selection of the bandwidth to use is a tradeoff between supporting higher data rates (wide channel bandwidth), and having a larger number of different non-interfering channels to use in the distributed Wi-Fi system 10. In some embodiments, the optimization tries to use the lowest possible channel bandwidth for each link that will support the load required by the various user's applications. By using the narrowest sufficient throughput channels, the maximum number of non-interfering channels are left over for other links within the distributed Wi-Fi system 10.

In some embodiments, the optimization process derives outputs from the inputs by maximizing a chosen objective function, of which there are numerous possibilities. One potential objective is to maximize aggregate client throughput, which may inadvertently neglect some clients to benefit others. Another objective might be to boost the throughput of the least-served client, promoting fairness but potentially sacrificing overall capacity for minor gains. Still another object may be to minimize disruptions to service when switching between Wi-Fi networks.

In some embodiments, the system is configured to consider individual client load requirements, aiming to maximize surplus capacity relative to these loads. This strategy enhances network robustness, reduces latency, and minimizes jitter by optimizing capacity distribution between access points (APs) in proportion to load ratios. To refine this approach, a softer optimization function can be employed, assigning capacities on a variable scale. High utility is attributed to achieving throughput that exceeds a client's required load, with diminishing returns for throughput beyond this threshold. This softer weighted function facilitates a more advantageous distribution of excess performance across devices.

In some embodiments, another set of optimization outputs defines the topology of the distributed Wi-Fi system 10, meaning which nodes connect to which other nodes. In some embodiments, the actual route through the distributed Wi-Fi system 10 between two clients or the client and the Internet gateway (modem/router 18) is also an output of the optimization. Again, the optimization attempts to choose the best tradeoff in the route. Generally, traversing more hops makes each hop shorter range, higher data rate, and more robust. However, more hops add more latency, more jitter, and depending on the channel frequency assignments, takes more capacity away from the rest of the system.

In some embodiments, learning algorithms are utilized on data stored in the cloud to identify trends and patterns, as indicated in step 56. The servers 20 can archive node measurements, optimization results, and subsequent measurements post-optimization. This data can be analyzed to discern patterns and trends for various applications. Given that network reconfiguration is time-consuming and can disrupt active communication, it is advantageous to prepare the network for peak load in advance. In some embodiments, historical data can be leveraged to predict future usage and interference. Other applications of learning from captured data include bug identification and discovery in client device behavior.

The network's performance can be evaluated and communicated to the user or to a service provider whose services are delivered over Wi-Fi, as indicated in step 57. In some embodiments, an application (like a mobile app on user device 22) can offer the user insight into network operations, as shown in step 58. This includes displaying network activity and performance metrics. The mobile app can be used to relay information to the user, take measurements, and allow the user to control certain aspects of the Wi-Fi network operations. The mobile app also communicates with the internet via the cellular system to aid in setting up the nodes initially. The mobile app, through the cellular system, enables the Wi-Fi network to connect with the internet and cloud when the user's regular internet connection is down. This cellular-based connection can be used to signal status, notify the service provider and other users, and can even be used to transfer data from the home to the internet when the user's regular internet connection is not working.

The configuration and optimization process 50 discussed herein with reference to the distributed Wi-Fi system 10 is non-limiting. Those skilled in the art will understand that the configuration and optimization process 50, as well as the tunneling protocols described herein, can function with any type of multi-node Wi-Fi system (i.e., a distributed Wi-Fi network or Wi-Fi system) including the Wi-Fi mesh network 32, the Wi-Fi repeater network 33, etc. For instance, cloud-based control can also be implemented in the Wi-Fi mesh network 32, the Wi-Fi repeater network 33, etc., and the various systems and methods described herein can operate effectively for cloud-based control and optimization. Also, the terms “distributed Wi-Fi network” or “Wi-Fi system” can also apply to the Wi-Fi mesh network 32, the Wi-Fi repeater network 33, etc., while the distributed Wi-Fi system 10 is a distributed Wi-Fi network according to some embodiments. In other words, the distributed Wi-Fi system 10 is similar to the Wi-Fi mesh network 32, the Wi-Fi repeater network 33, etc., in that it supports multiple nodes, but it has the aforementioned distinctions to overcome limitations associated with each. In some embodiments, one or more nodes may be powered by different network providers (e.g., AT&T®, Verizon®), where the tunneling protocol described herein enables a seamless transition between provider networks.

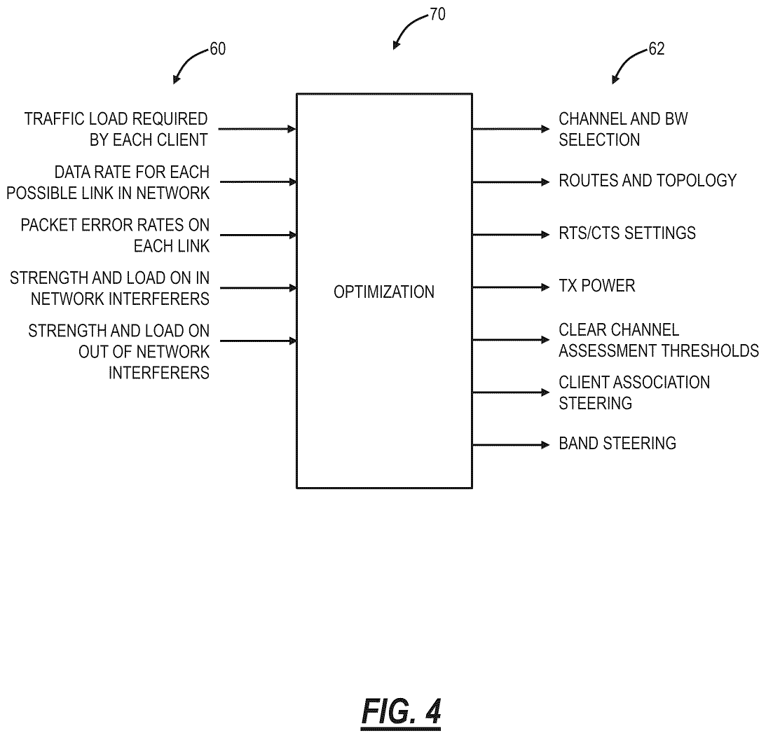

FIG. 4 depicts a block diagram outlining inputs 60 and outputs 62 to an optimization 70 within the system according to some embodiments. Inputs 60 may comprise traffic load required by each client device, signal strengths between nodes and between access points 14 and Wi-Fi client devices 16, data rate for each potential link in the network, packet error rates on each link, strength and load on in-network interferers, and strength and load on out-of-network interferers. These inputs are derived from measurements and data collected by access points 14 and transmitted to servers 20 in cloud service 40. Servers 20 are configured to execute optimization 70. Outputs of optimization 70 can include channel and bandwidth (BW) selection, routes and topology, Request to Send/Clear to Send (RTS/CTS) settings, Transmitter (TX) power, clear channel assessment thresholds, client association steering, and band steering.

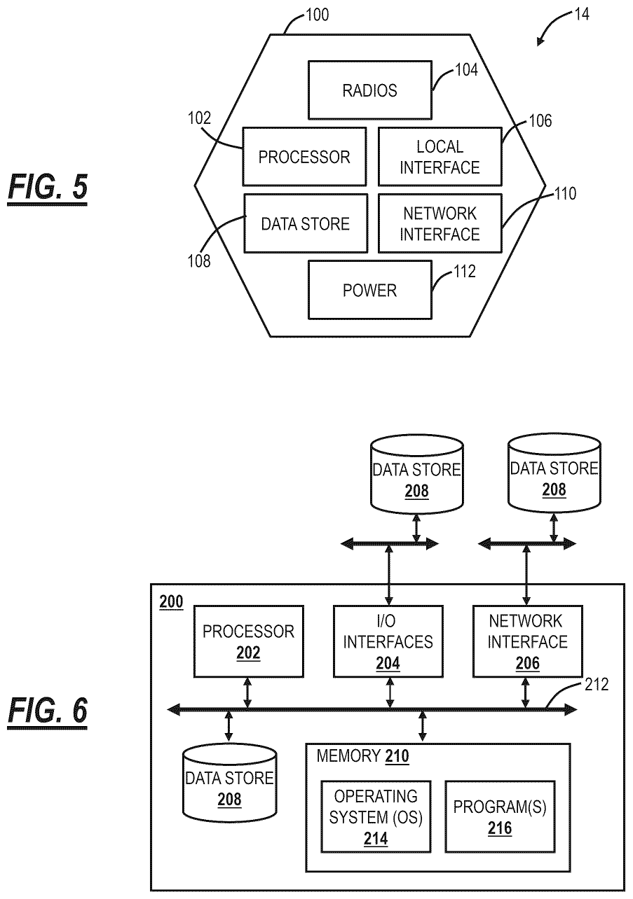

FIG. 5 illustrates a block diagram showcasing functional components of access point 14 within distributed Wi-Fi system 10. In some embodiments, access point 14 comprises a physical form factor 100 housing a processor 102, multiple radios 104, a local interface 106, a data storage unit 108, a network interface 110, and a power supply 112. It is understood by those skilled in the art that FIG. 5 simplifies the actual complexity of access point 14, which may include additional components and sophisticated processing logic to support both the functionalities described herein and other standard or advanced features not detailed herein.

In some embodiments, the form factor 100 embodies a compact physical structure wherein access point 14 is configured for direct insertion into an electrical outlet, supported by the electrical plug connection. This compact design is well-suited for extensive deployment of access points 14 within a residential setting. Processor 102 functions as a hardware component to execute software instructions and may encompass any custom or commercially available processor, a central processing unit (CPU), an auxiliary processor among several processors within a mobile device, a semiconductor-based microprocessor in microchip or chipset form, or any device capable of executing software instructions. During operation, processor 102 executes software stored in data storage 108, manages data communication to and from data storage 108, and oversees the general operations of access point 14 as dictated by the software. In some embodiments, processor 102 may include a mobile-optimized processor tailored for power efficiency and mobile applications.

In some embodiments, radios 104 facilitate wireless communication within distributed Wi-Fi system 10. These radios 104 are capable of operating in compliance with IEEE 802.11 standards. They incorporate address, control, and data connections that enable proper communication within the distributed Wi-Fi system 10. In some embodiments, access point 14 is equipped with multiple radios to maintain various links, including backhaul and client links. In some embodiments, optimization 70 dictates the configuration of radios 104, such as bandwidth, channels, and topology. Access points 14, in some embodiments, are capable of dual-band operation, concurrently supporting 2.4 GHz and 5 GHz 2×2 MIMO 802.11b/g/n/ac radios with operational bandwidths of 20/40 MHz for 2.4 GHz and 20/40/80 MHz for 5 GHz. For instance, access points 14 may accommodate IEEE 802.11AC1200 gigabit Wi-Fi, achieving speeds of 300+867 Mbps.

The local interface 106 is configured for local communication to the access point 14 and can be either a wired connection or wireless connection such as Bluetooth® or the like. Since the access points 14 are configured via the cloud 12, an onboarding process is required to first establish connectivity for a newly turned on access point 14. In some embodiments, the access points 14 include local interface 106 allowing connectivity to the user device 22 (or a Wi-Fi client device 16) for onboarding to the distributed Wi-Fi system 10 such as through an app on the user device 22. Data store 108 is used to store data, and may include any of volatile memory elements (e.g., random access memory (RAM, such as DRAM, SRAM, SDRAM, and the like)), nonvolatile (non-transitory) memory elements (e.g., ROM, hard drive, tape, CD-ROM, and the like), and combinations thereof. Moreover, the data store 108 may incorporate electronic, magnetic, optical, and/or other types of storage media.

The network interface 110 offers wired connectivity to access point 14 which may be utilized to facilitate communication between access point 14 and modem/router 18. Additionally, network interface 110 can provide local connectivity to a Wi-Fi client device 16 or user device 22. For instance, a device that doesn't support Wi-Fi can be wired to access point 14 to gain network access. In some embodiments, all access points 14 within the distributed Wi-Fi system 10 are equipped with network interface 110. In some embodiments, only select access points 14 that connect to the modem/router 18 or require local wired connections include network interface 110. Network interface 110 could comprise an Ethernet card or adapter (e.g., 10BaseT, Fast Ethernet, Gigabit Ethernet, 10 GbE), and may include address, control, and/or data connections to enable appropriate communications on the network.

In some embodiments, the processor 102 and data store 108 includes software and/or firmware that essentially governs the operation of access point 14, including data collection and measurement control, data management, memory management, and communication and control interfaces with server 20 via the cloud. In some embodiments, the processor 102 and data store 108 (i.e., memory) can be configured to execute various processes, algorithms, methods, techniques, etc., as described herein.

Referring to FIG. 6, the server 200, which may be used in conjunction with a Wi-Fi device and/or a client device, is depicted with its core components, including one or more processors 202, I/O interfaces 204, a network interface 206, data storage 208, and memory 210, interconnected via a local interface 212. This simplified representation underscores the server's capability to support a wide range of functionalities related to cloud-based Wi-Fi network management.

The server 200 includes components such as one or more processors 202, I/O interfaces 204, a network interface 206, data storage 208, and memory 210, all of which are communicatively coupled via a local interface 212. The local interface 212 may include one or more buses or other wired or wireless connections. Additionally, the local interface 212 may incorporate various elements not depicted for simplicity, including controllers, buffers (caches), drivers, repeaters, and receivers, to facilitate communications. Moreover, the local interface 212 is equipped with address, control, and data connections to enable appropriate communications among the aforementioned components.

The processor 202 executes software instructions stored on one or more non-transitory computer readable media and may be a custom or commercial processor, a CPU, an auxiliary processor among several processors associated with the server 20, a semiconductor-based microprocessor in microchip or chipset form, or any device executing software instructions. When operational, the processor 202 executes software from memory 210, communicates data to and from memory 210, and controls server 20 operations as directed by software instructions. I/O interfaces 204 receive user input and provide system output. User input via devices like keyboards, touchpads, and mice. System output via display devices and printers, not depicted. I/O interfaces 204 may comprise interfaces such as serial port, parallel port, SCSI, SATA, fibre channel, Infiniband, iSCSI, PCI-x, IR interface, RF interface, and USB interface.

The network interface 206 enables server 20 network communication, including for cloud 12. Network interface 206 may comprise Ethernet cards or adapters (for instance, 10BaseT, Fast Ethernet, Gigabit Ethernet, 10 GbE) or WLAN cards or adapters (such as 802.11a/b/g/n/ac), and/or includes address, control, and data connections for network communications. Data store 208 stores data and may include volatile memory (like RAM, including DRAM, SRAM, SDRAM, etc.), nonvolatile memory (such as ROM, hard drive, tape, CD-ROM), or combinations thereof. Data store 208 may use electronic, magnetic, optical, or other storage media types. For instance, data store 208 could be internal to server 20, like an internal hard drive connected to local interface 212, or external, like an external hard drive connected to I/O interfaces 204 via SCSI or USB. In some embodiments, data store 208 may connect to server 20 over a network, for example, a network-attached file server.

Memory 210 comprises volatile memory elements (e.g., RAM such as DRAM, SRAM, SDRAM), nonvolatile memory elements (e.g., ROM, hard drive, tape, CD-ROM), or some combination thereof. Memory 210 may include electronic, magnetic, optical, or other types of storage media. In some embodiments, memory 210 includes a distributed architecture, with components located remotely and accessible by processor 202. Software within memory 210 may comprise one or more programs with executable instructions for representing algorithm steps. In some embodiments, software includes an operating system (O/S) 214 and programs 216. O/S 214 oversees execution of computer programs, including programs 216, and manages scheduling, input-output, file and data, memory, communication control, and related services. Programs 216 are configured to perform processes, algorithms, methods, and techniques as described herein, for example, related to optimization 70.

Described systems and methods facilitate the transformation of an initial Wi-Fi network topology into a target topology, involving multiple distributed access points 14. These systems and methods operate with distributed Wi-Fi systems like Wi-Fi system 10, Wi-Fi mesh network 32, Wi-Fi repeater network 33, among others. In some embodiments, Wi-Fi network topology is defined by parent-child links among nodes, namely access points 14, and may optionally include links of access points 14 with Wi-Fi client devices 16. These links, forming the backhaul, may cover frequency bands, channels, and channel widths. Topology alterations are executed by dispatching a series of commands to the nodes, which could be directed by the cloud 12, a cloud controller, or a cloud-based service. These commands prompt access points 14 to adjust their radio settings 104 to establish the desired network configuration. Additionally, instructions might be sent to Wi-Fi client devices 16 to prompt them to switch channels, connect to an alternate access point 14, and/or execute tunneling protocols, further aiding in the realization of the target network topology.

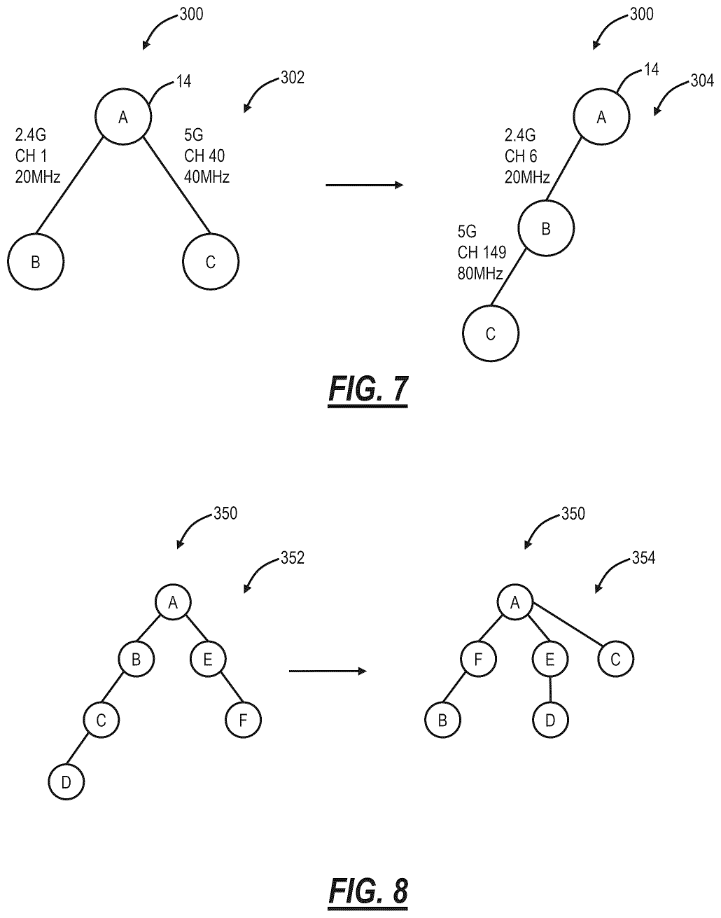

In reference to FIG. 7, a network diagram demonstrates a three-node Wi-Fi network 300 transition from a first topology state 302 to a second topology state 304. The Wi-Fi network 300 includes three access points 14, denoted as nodes A, B, and C, each operating a 2.4G and 5G radio 104. In the first topology state 302, node A serves as a parent node linked to node B via a 2.4G radio backhaul link on Ch. 1, 20 MHz, and to node C via a 5G radio backhaul link on Ch. 40, 40 MHz. The Wi-Fi network 300 then alters its topology to the second state 304, where node A remains the parent to node B, now connected by a 2.4G radio backhaul link on Ch. 6, 20 Hz. Node B becomes the parent to node C, connected via a 5G radio backhaul link on Ch. 149, 80 MHz.

Referring to FIG. 8, an example network diagram displays a six-node Wi-Fi network 350 transitioning between a first topology state 352 and a second topology state 354. The Wi-Fi network 350 comprises six nodes labeled A to F according to some embodiments.

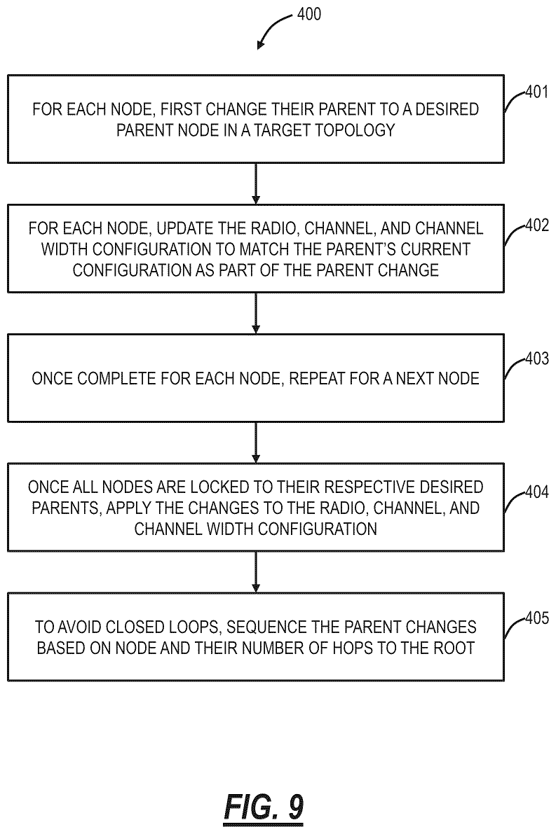

FIG. 9 shows a non-limiting example of a flowchart depicting one or more algorithm steps implemented by the system. In some embodiments, a first process 400 for topology change in Wi-Fi network 350 executes operations in a sequential manner. The first process 400 includes, for each node within the network, reconfiguring the node's parent to a predetermined parent node within the target topology, designated as the second topology state 354 (step 401). In some embodiments, the node's radio, channel, and channel width settings are adjusted to align with the configurations of the newly assigned parent node as part of the reconfiguration command (step 402). In some embodiments, the first process 400 further includes a step of pausing until the reconfiguration of the parent node is completed before proceeding to the subsequent node to replicate steps 401 and 402 (step 403). Upon successful reconfiguration of all nodes to their respective target parent nodes, the system applies the predetermined radio, channel, and channel width settings across all nodes (step 404). To prevent the creation of closed network loops that disrupt the path to the root node or Internet connection, typically through a gateway node, the reconfiguration of parent nodes is strategically sequenced, beginning with nodes that are the furthest removed, in terms of hops, from the root node (step 405).

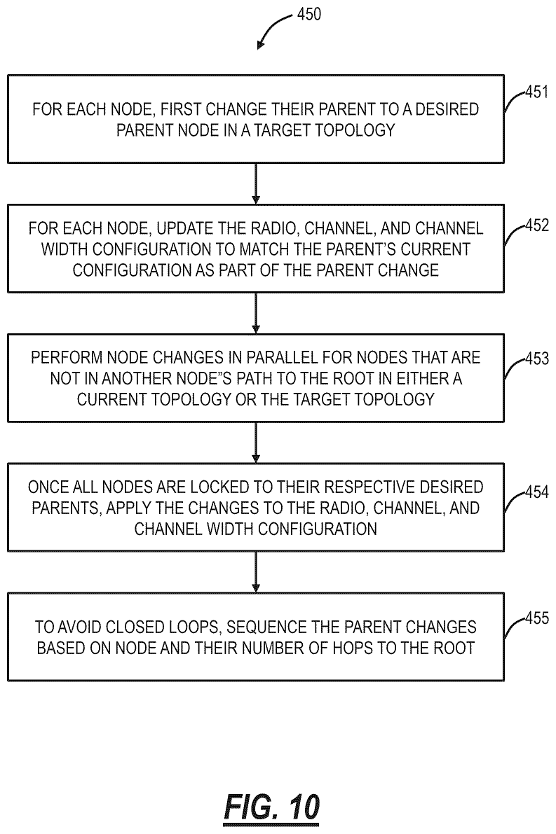

FIG. 10 shows a flowchart depicting a second process 450 for topology modification within Wi-Fi network 350, executing concurrent alterations. The second process 450 enhances the first process 400 by incorporating optimizations. Specifically, the second process 450 involves, for each node, initially reassigning their parent to a predetermined parent node within the target topology state 354 as indicated at step 451. Concurrently, if required, the node's radio, channel, and channel width settings are adjusted to align with the target parent's configuration as part of the parent reassignment command, as described at step 452. Rather than executing the steps 451, 452 in a sequential manner, the second process 450 introduces an optimization to minimize the duration required to actualize the target topology state 354. This optimization comprises executing compatible operations simultaneously as delineated in step 453. A group of parent reassignment operations is deemed compatible if, for the set of nodes involved, no node is situated within another node's route to the root in either the current or target topology. This condition guarantees uninterrupted connectivity to the Internet for each node immediately preceding and subsequent to each operation. Subsequent to securing all nodes to their respective designated parents, the intended radio, channel, and channel width configurations are collectively applied to the nodes as outlined in step 454. To prevent the formation of closed loops devoid of a route to the root node/Internet (via the gateway node), the sequence of parent changes is initiated with nodes positioned at the furthest distance in terms of hops from the root, as detailed in step 455.

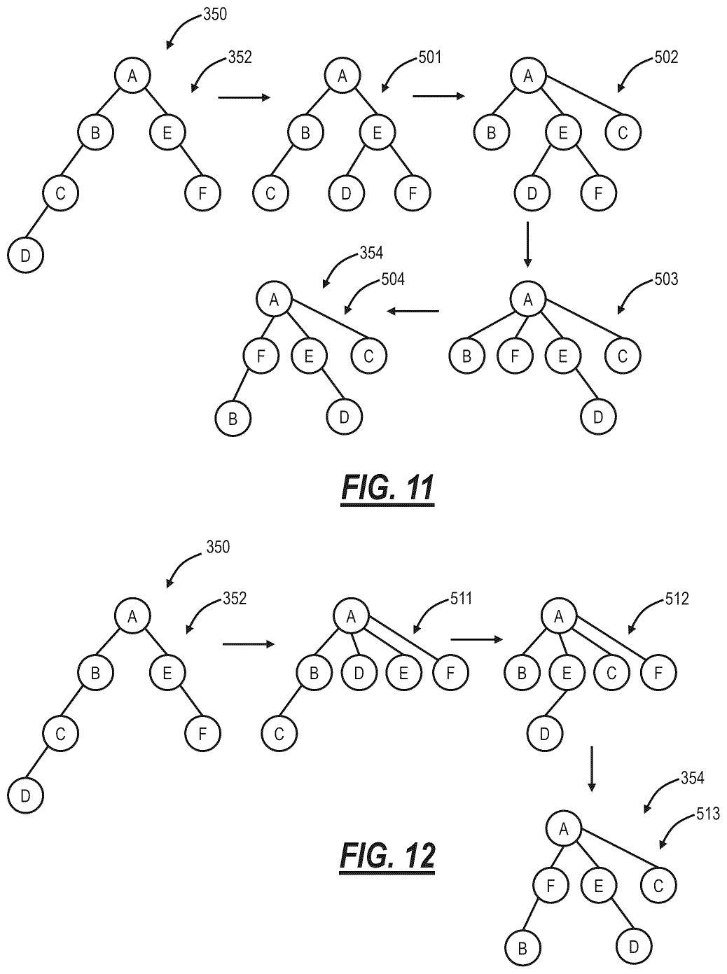

FIG. 11 shows a diagram outlining the operational stages of the first process 400. Initially, Wi-Fi network 350 is situated in the initial topology state 352. The first process 400 transitions Wi-Fi network 350 through a sequence of four steps 501, 502, 503, 504, culminating in the second topology state 354. Commencing with step 501, the inaugural node, designated as node D, transitions from its existing parent node C to a new parent node E. Subsequently, at step 502, the second node in the sequence, node C, migrates from its current parent node B to a newly assigned parent node A. Progressing to step 503, the third node, node F, is repositioned from its present parent node E to a new parent node A. Concluding the sequence at step 504, the fourth node, node B, is transferred from its original parent node A to a new parent node F. Following the completion of step 504, Wi-Fi network 350 attains the target topology, denoted as the second topology state 354. In some embodiments, nodes transition from their current parent nodes to the newly designated parent nodes in the absence of child nodes. In some embodiments, the nodes are relocated in a sequential manner, with one node being moved at a time. The first process 400 may determine the sequence of node selection at each step by prioritizing the node that is furthest from the root node, as measured by the number of hops, and that has no child nodes.

FIG. 12 illustrates the operational phases of the second process 450. In some embodiments, Wi-Fi network 350 originates in the first topology state 352. Through the second process 450, Wi-Fi network 350 undergoes a series of three steps 511, 512, 513, transitioning to the second topology state 354, thereby streamlining the first process 400 by one step via optimization. Initially, at step 511, a cohort of nodes, specifically nodes D and F, are concurrently repositioned as neither node D nor node F resides on a mutual path to the root node A in either the initial or ultimate topology. Nodes D and F are reassigned to their new parent node A. Subsequently, at step 512, another set of nodes, comprising nodes C and D, is concurrently moved, given that neither node C nor node D shares a path to the root node A. At step 513, node B is selected and transitioned to its new parent node F. Upon the completion of step 513, Wi-Fi network 350 achieves the desired topology, identified as the second topology state 354.

Referring to steps 404, 454, in some embodiments, the reconfiguration of nodes as delineated in steps 403, 453 may initially involve the subordinate node establishing a connection to the newly designated parent node utilizing existing configurations, namely radio, channel, and channel width. Subsequent to this association, the updated configurations, specifically radio, channel, and channel width, are collectively instituted while Wi-Fi network 350 is situated in the new topology state 352. As a result, uninterrupted connectivity is maintained within Wi-Fi network 350 throughout the topology alteration procedures 400, 450. This ensures the preservation of a continuous route to the root within Wi-Fi network 350, as nodes are sequentially transitioned, focusing on those without subordinate nodes. Additionally, the cloud service and/or Wi-Fi network 350 may transition any Wi-Fi client devices 16 prior to the repositioning of a node, thereby safeguarding against data loss during the topology modification. Moreover, the topology alteration procedures 400, 450 may be executed during periods of reduced network activity, for instance, during late-night hours.

In some embodiments, client devices encounter challenges when roaming across different Wi-Fi networks, such as transitioning from a home network to a neighbor's network, or moving between stores in a shopping mall, as the Wi-Fi networks may include different providers.

A BSSID includes the MAC (Media Access Control) address of the wireless access point (WAP) generated by a router. This MAC address is used to identify a particular wireless network in the area. Each BSSID represents a different wireless network within the same area or the same router, which is useful in a situation where there are multiple Wi-Fi networks. Each time a device, such as an iPhone®, connects to a new BSSID, which represents a different Wi-Fi network, the device is assigned a new public IP address by the current BSSID network. This is due to each Wi-Fi network having its own Network Address Translation (NAT) that translates the device's private IP, which is unique within that particular network, to a public IP that is globally unique. This process is akin to assigning unique license plates for devices to navigate the internet highways. Consequently, for a device to access the internet, it must be assigned a public IP, typically without regard to quality of service, potentially leading to reduced speeds, lost connections, or buffering.

An Extended Service Set (EES) includes a set of one or more interconnected Basic Service Sets (BSS) and their associated LANs that appear as a single BSS to the logical link control layer at any station associated with one of those BSS. Essentially, an ESS is a group of BSSs connected to the same network. When a user moves between different ESS-es, they're moving between different network areas. Each of these networks may have its own Network Address Translation (NAT) system, which can cause issues as each one will translate the user's device's private IP address differently.

A problem arises when a user roams between different ESS-es, resulting in the deployment of a different NAT for each network to translate the client's private IP to a global public IP. This translation process allows multiple devices to share a single public IP address provided by the Internet Service Provider, which optimizes IP address usage and adds an extra layer of security since the private IP addresses are not directly exposed to the internet. However, this frequent reassignment of public IPs during roaming can lead to a degradation in the Quality of Service (QoS). For instance, if a user is engaged in a Zoom call and roams from one Wi-Fi network to another, the call data is trafficked over two different public IPs, causing disruptions and a suboptimal user experience.

In some embodiments, the system is configured to link one or more Wi-Fi Access Points (APs) between Wi-Fi networks using a tunneling protocol, enabling seamless roaming transitions across networks. Utilizing cloud-based servers, such as those provided by Plume Design, Inc., for example, the system identifies the Wi-Fi AP node to which the client is currently connected. Techniques previously described are employed to range nearby Wi-Fi AP nodes, include those on different Wi-Fi networks, and group those closest to the current node. This configuration prepares access points in proximity to the user to anticipate potential connections from the user's equipment, wherein the tunneling protocol use a dedicated, per-user, User Datagram Protocol (UDP) based tunnel terminated in a cloud endpoint, where the UDP-based tunnel does not require an acknowledgement, or handshake.

The tunneling protocol has features that include cryptographic identity, automatic silent keep-alives, endpoint updates, and quick connection establishment, among other software and enabling systems. In some embodiments, the system is configured to use one or more of these features to create a network where one or more APs have a tunnel pre-provisioned for each client that may connect. In some embodiments, the one or more APs are selected using the grouping and optimization described herein, which can span access different networks. When a client's device elects to roam, the new AP assumes control of the active tunneling session, triggering route updates.

A frame includes a package of information that includes not just the core data being sent, but also source and destination addresses, error checking (checksum), and/or control information. A cryptographically correct frame includes a data packet that has been appropriately encrypted or signed for security purposes. In some embodiments, a single cryptographically correct frame from the new ESS's NAT is sufficient to update paths and maintain the ongoing connection.

In some embodiments, the tunneling protocol described herein is particularly beneficial for devices that frequently change network environments, such as smartphones transitioning from a Wi-Fi network to a cellular network. The protocol's statelessness, cryptographic identity, automatic silent keep-alives, endpoint updates, absence of complex handshakes, and rapid connection establishment contribute to its ability to provide seamless transitions.

In some embodiments, the tunneling protocol uses VPN to establish secure tunnels to a central cloud sever system. Unlike traditional VPNs, in some embodiments, the tunneling protocol implemented by the system is stateless with respect to actual connections. This means the tunneling protocol doesn't keep any session state about a connection. Instead, the tunneling protocol is configured to use cryptographic keys to recognize and secure packets. If a device changes its IP address (like when switching from Wi-Fi to mobile data), the tunneling protocol is configured to recognize the device based on its cryptographic identity, not its IP address. In some embodiments, the tunneling protocol includes a roaming feature configured to prevent VPN disconnections during network switches.

In some embodiments, each peer in a system network is identified by its public key. In some embodiments, the tunneling protocol is configured to establish a consistent cryptographic identity (the keys) between W-Fi networks for a given client device, enabling the network address to change without affecting the established connection provided by the tunneling protocol. Traditional VPN protocols often involve complex handshakes and renegotiations when roaming between networks, while the tunneling protocol described herein uses static cryptographic keys which eliminate this need, making transitions between Wi-Fi networks unnoticeable to a user. In some embodiments, interruption times between Wi-Fi networks and or APs is less than 1 second.

In some embodiments, the tunneling protocol is configured to send occasional (silent) keep-alive packets to ensure NAT (Network Address Translation) mappings remain alive during periods of inactivity. This helps in scenarios where a device's network environment changes, ensuring that the path remains open for subsequent packets.

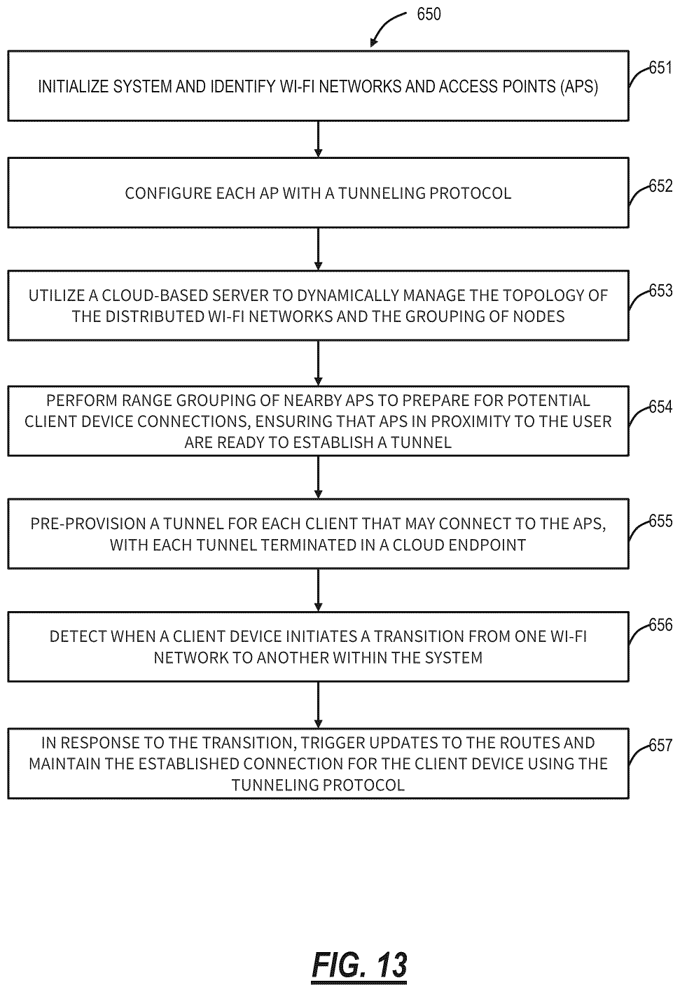

Turning attention to FIG. 13, a flowchart 650 delineates a series of operations for implementing a tunneling protocol within a distributed Wi-Fi network. The initial operation, Step 651, involves the system initialization and identification of all Wi-Fi networks and Access Points (APs), cataloging the network components for subsequent configuration.

Subsequent to initialization, Step 652 configures each AP with a tunneling protocol. At Step 653, the system engages a cloud-based server to dynamically manage the topology of the distributed Wi-Fi networks and the grouping of nodes. This centralized management enables the system to adapt to changing network conditions and client device movements, optimizing network performance.

At Step 654, the system executes range grouping of nearby APs, preparing for potential client device connections. This process positions APs in proximity to the user to anticipate and establish a tunnel when a client device connects. In step 655, the system pre-provisions a tunnel for each client that may connect to the APs, with each tunnel terminated in a cloud endpoint. This pre-provisioning ensures that tunnels are ready to be activated as soon as a client device initiates a connection, minimizing connection establishment time.

At Step 656, the system detects when a client device initiates a transition from one Wi-Fi network to another. At step 657, the system triggers updates to the routes in response to the client device's transition and maintains the established connection using the tunneling protocol, ensuring that the client device experiences no interruption in service as it moves across the Wi-Fi networks.

The disclosure describes the specifics of how a machine including one or more computers comprising one or more processors and one or more non-transitory computer readable media implements the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations thereof (e.g., the system display can show X) are used for descriptive purposes only and are understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the system can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable, and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications, and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

We claim:

1. A method comprising steps of:
configuring a plurality of Wi-Fi networks with a tunneling protocol;
detecting a transition of a client device from a first Wi-Fi network to a second Wi-Fi network within the plurality of Wi-Fi networks; and
maintaining an ongoing connection for the client device utilizing the tunneling protocol during the transition.

2. The method of claim 1, wherein the tunneling protocol includes User Datagram Protocol (UDP).

3. The method of claim 2, wherein the tunneling protocol does not require an acknowledgement.

4. The method of claim 1, further comprising a step of:
utilizing a cloud-based server to manage a topology state of each of the plurality of Wi-Fi networks.

5. The method of claim 1, further comprising a step of:
triggering updates to network routes upon the client device connecting to the second Wi-Fi network.

6. The method of claim 1, further comprising a step of:
configuring one or more access points to have a tunnel pre-provisioned for one or more clients that may connect to the one or more access points.

7. The method of claim 1, further comprising a step of:
configuring the tunneling protocol to be stateless with respect to actual connections.

8. The method of claim 1, further comprising a step of:
using a single cryptographically correct frame from a new Extended Service Set's (ESS's) Network Address Translation (NAT) to update paths and maintain an established connection.

9. The method of claim 8, further comprising a step of:
enabling a network address to change without affecting the established connection provided by the tunneling protocol.

10. The method of claim 1, further comprising a step of:
sending occasional keep-alive packets to ensure NAT mappings remain alive during periods of inactivity.

11. A system comprising:
a plurality of Wi-Fi networks configured with a tunneling protocol to support roaming of a client device between Wi-Fi networks;
a cloud-based server configured to manage topology states of the Wi-Fi networks; and
a plurality of access points, wherein at least one access point is configured to assume control of an active tunneling session for the client device during roaming.

12. The system of claim 11, wherein the tunneling protocol includes cryptographic identity, automatic silent keep-alives, and/or includes User Datagram Protocol (UDP).

13. The system of claim 11, wherein the tunneling protocol is stateless with respect to actual connections and uses cryptographic keys to recognize and secure packets.

14. The system of claim 11, wherein the tunneling protocol is configured to prevent VPN disconnections during network switches.

15. The system of claim 11, wherein the system is configured to update routes in response to receiving a single cryptographically correct frame from a new Extended Service Set's (ESS's) Network Address Translation (NAT).

16. The system of claim 11, wherein the system is configured to maintain a consistent cryptographic identity for the client device across different Wi-Fi networks.

17. The system of claim 11, wherein the system is configured to perform a range grouping of nearby Wi-Fi access points to prepare for potential client device connections.

18. The system of claim 17, wherein the system is configured to create a tunnel for each of the plurality of access points that one or more clients may connect to in the range grouping.

19. The system of claim 11, wherein each peer in the plurality of Wi-Fi networks is identified by a public key.

20. A non-transitory computer-readable storage medium tangibly encoded with computer-executable instructions, that when executed by a processor, cause a computer to perform steps comprising:
configuring a plurality of Wi-Fi networks with a tunneling protocol;
detecting a transition of a client device between Wi-Fi networks within the plurality of Wi-Fi networks; and
maintaining an ongoing connection utilizing the tunneling protocol during the transition of the client device.
